(19) United States
(12) Patent Application Publication
(10) Pub. No.: US 2013/0103447 A1
(43) Pub. Date: Apr. 25, 2013

(54) USING SOCIAL AND CONTEXTUAL MECHANICS TO AID TASK COMPLETION

(71) Applicants: Greg Scott Melander, Renton, WA (US); Sameer Halai, Seattle, WA (US); Flynn Thayer Joffray, Vashon, WA (US); Nathanael Paul Roberton, Forest Lake Park, WA (US); Craig Arthur Jensen, Sammamish, WA (US)

(72) Inventors: Greg Scott Melander, Renton, WA (US); Sameer Halai, Seattle, WA (US); Flynn Thayer Joffray, Vashon, WA (US); Nathanael Paul Roberton, Forest Lake Park, WA (US); Craig Arthur Jensen, Sammamish, WA (US)

(73) Assignee: Microsoft Corporation, Redmond, WA (US)

(21) Appl. No.: 13/279,354

(22) Filed: Oct. 24, 2011

(51) Int. Cl. G06Q 10/06; G06Q 30/02

(52) U.S. Cl. 705/7.15; 705/14.1; 705/14.73

(57) ABSTRACT

A user declares an intention to perform a task in a social network. The system allows others, connected to the user within the social network, to provide social input that expresses interest in the task declared by the user and uses social mechanics to express support to the user and to assist in keeping the user motivated to perform the task. When the task is complete, the system notifies the other users (the stakeholders) and awards incentive.

### BACKGROUND

With the current pace of life, it can be difficult to keep track of tasks that need to be completed. It can also be difficult to stay motivated to get them done. People often have intentions (or make resolutions) to do certain things, but because of distractions and for other reasons, it can be very difficult to reach the point of completion.

Some current, automated, systems attempt to address this problem. For instance, there are a variety of different, automated to-do lists and reminder systems. However, these systems often require a great deal of self motivation, and significant discipline, in order to be effective.

A social network is a social structure made up of individuals or organizations referred to as nodes or users. The nodes or users are connected by one or more specific types of interdependency, such as friendship, kinship, common interests, related beliefs, or knowledge, to name a few. Social network sites are currently popular. Social network sites provide on-line services, platforms, or other site-specific functions, that focus on building social networks among users based on social interdependency of those users. Some social network services are web-based and provide means for users to interact, over a wide area network.

Such social network sites provide computer-implemented social interaction by publishing posts from an individual user to a public stream that is distributed to other individuals connected, through interdependency, to the user that authored the post. The individuals that receive the public stream are generally known to one another, and thus facilitate a social context among the various communications of the users.

The discussion above is merely provided for general background information and is not intended to be used as an aid in determining the scope of the claimed subject matter.

### SUMMARY

A user declares an intention to perform a task in a social network. The system allows others, connected to the user within the social network, to provide social input that expresses interest in the task declared by the user and uses social mechanics to express support to the user and to assist in keeping the user motivated to perform the task. When the task is complete, the system notifies the other users (the stakeholders) and awards incentive.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative social task monitoring system.

FIG. 2 is a flow diagram illustrating one illustrative embodiment of the overall operation of the system shown in FIG. 1.

FIGS. 2A-2F are illustrative user interface displays generated by the system shown in FIG. 1.

FIG. 3 is a flow diagram illustrating one illustrative embodiment of receiving social input.

FIG. 4 is a flow diagram showing one illustrative embodiment of identifying and employing social mechanics.

FIG. 5 is a flow diagram illustrating one illustrative embodiment for post completion processing.

FIG. 6 is a flow diagram illustrating one illustrative embodiment of vendor interaction.

FIGS. 7-9 show different embodiments of mobile devices.

FIG. 10 is a block diagram showing one illustrative embodiment of a computing environment.

### DETAILED DESCRIPTION

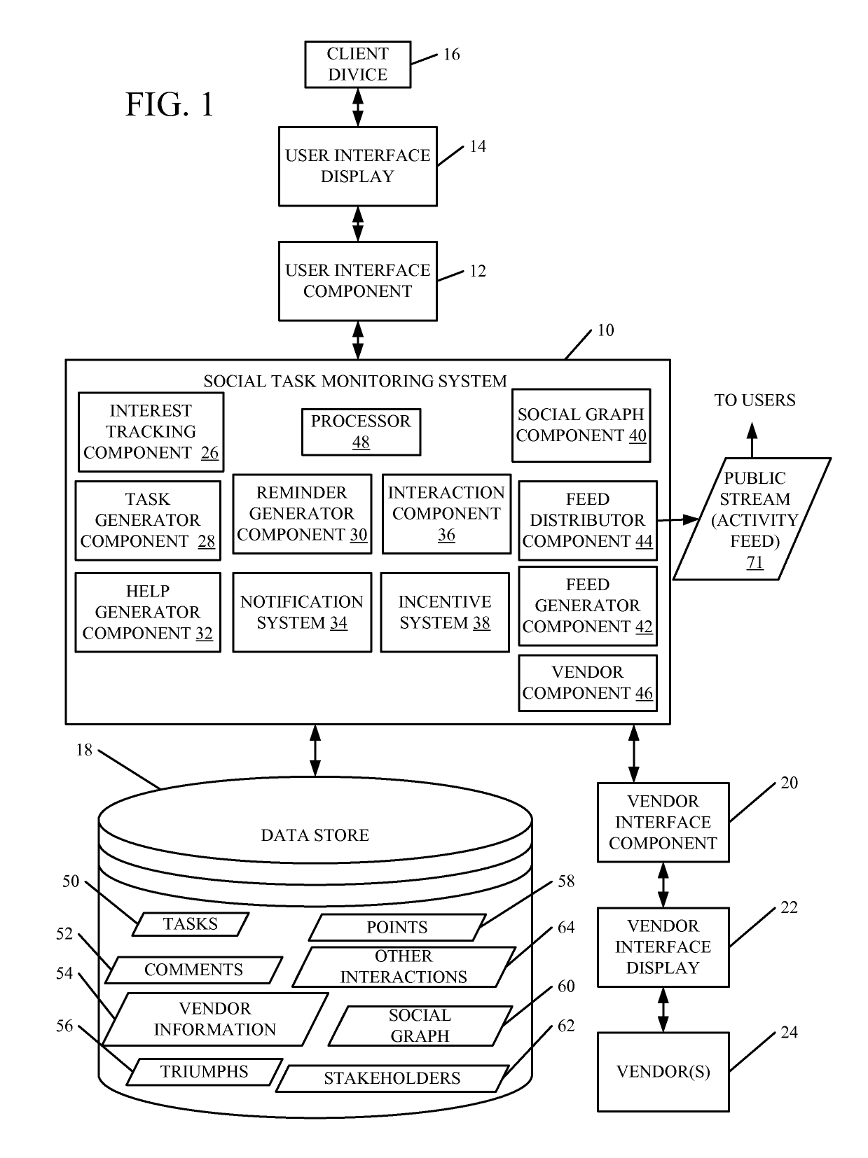

FIG. 1 is a block diagram of one illustrative embodiment of social task monitoring system 10. FIG. 1 shows that social task monitoring system 10 is coupled to a user interface component 12 that generates user interface displays 14 for a client device 16 used by a user. FIG. 1 also shows that social task monitoring system 10 is coupled to data store 18. System 10 can also include vendor interface component 20 that generates vendor interface displays 22 for one or more vendors 24. Of course, it will be noted that the various components shown in FIG. 1 can all be part of social task monitoring system 10, or separate therefrom. In addition, they can all reside on a client device 16, or remotely, or various components can be located on a client device 16 while others are located remotely from the client device 16. They are illustrated as shown in FIG. 1 for the sake of example only.

FIG. 1 also shows that social task monitoring system 10 illustratively includes interest tracking component 26, task generator component 28, reminder generator component 30, help generator component 32, notification system 34, interaction monitoring component 36, incentive system 38, social graph component 40, feed generator component 42, feed distributor component 44 and vendor component 46. System 10 also includes processor 48 that can be activated by the various other components of system 10 to facilitate their functionality.

In the embodiment shown in FIG. 1, data store 18 illustratively stores tasks 50, comments 52, vendor information 54, triumphs 56, points 58, social graph 60, stakeholders 62 and data corresponding to a variety of other interactions 64.

In one illustrative embodiment, social task monitoring system 10, and specifically social graph component 40, facilitates social network services and thus tracks the connection of nodes of a social network, represented by social graph 60, based on various types of interdependencies. The nodes illustratively correspond to clients 16. In one embodiment, components 42 and 44 handle functions associated with maintaining a social graph (which can be stored as social graph 60 in data store 18) that connects the users (or nodes) in the social network based on their interdependency, and also handles generating and distributing a public stream (or activity feed) 71 of information among the connected users. Interest tracking component 26 can be used to either explicitly or implicitly track the interests of the various users, and this can be used by social graph component 40 in generating and monitoring social graph 60.

Social task monitoring system 10 illustratively integrates the social aspects of the social network facilitated by components 40, 42, and 44 (and possibly other components) into the process of helping individual users identify tasks to be completed. System 10 employs social mechanics in assisting the completion of those tasks.

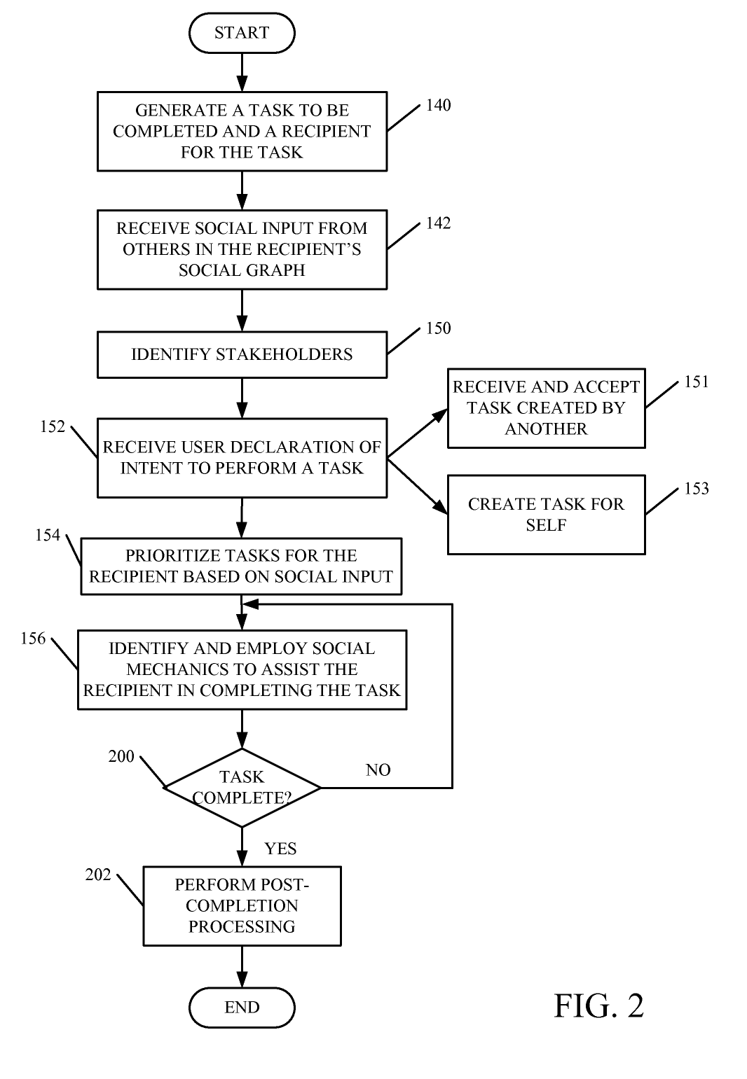

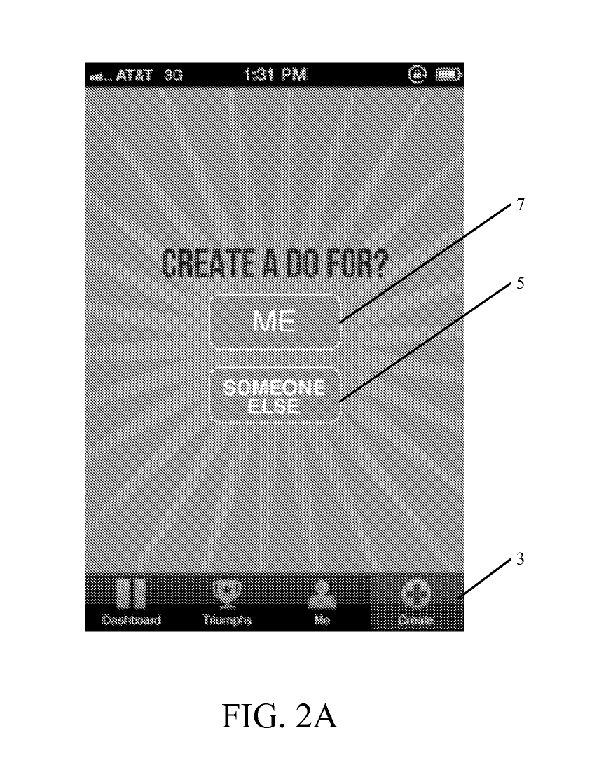

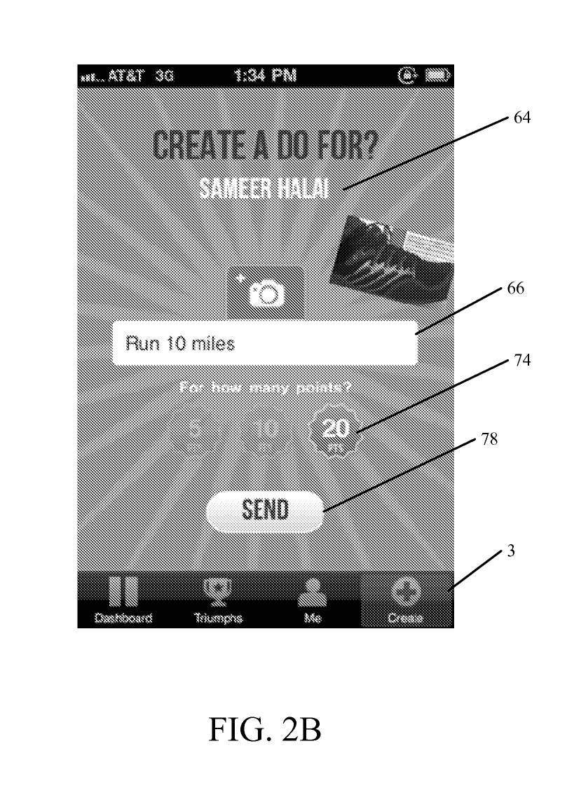

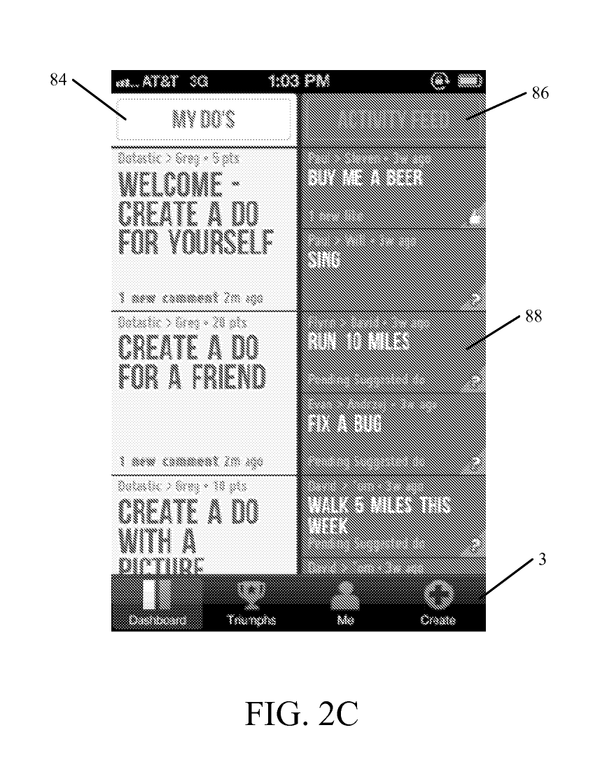

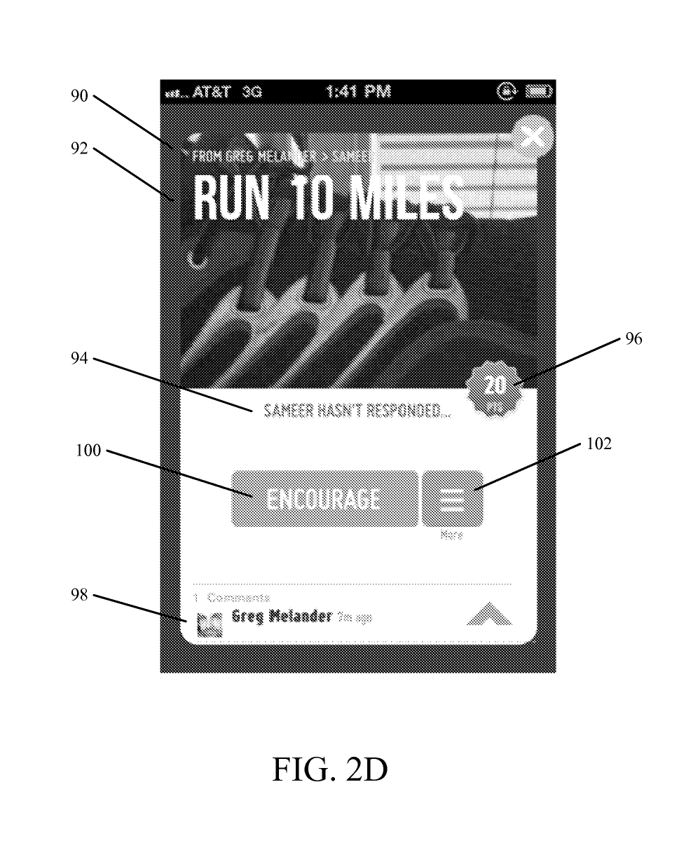

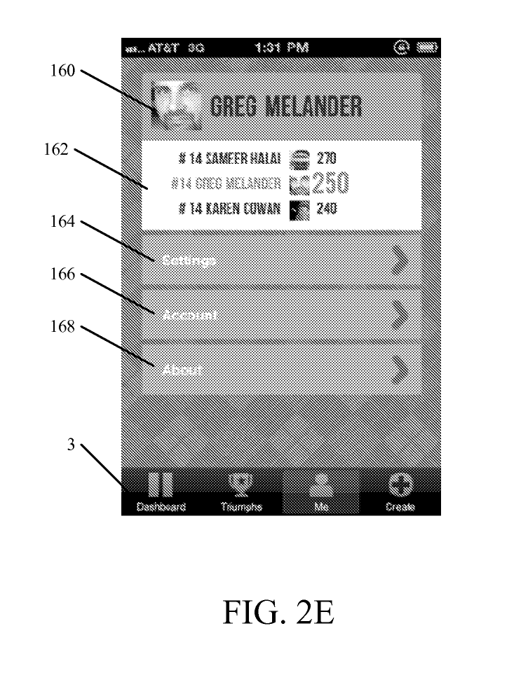

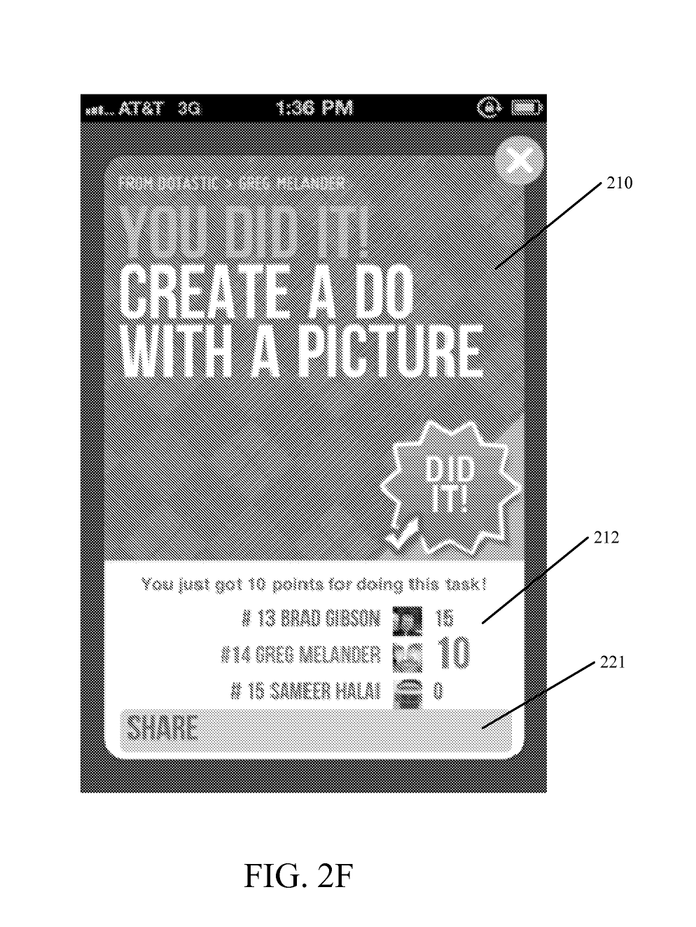

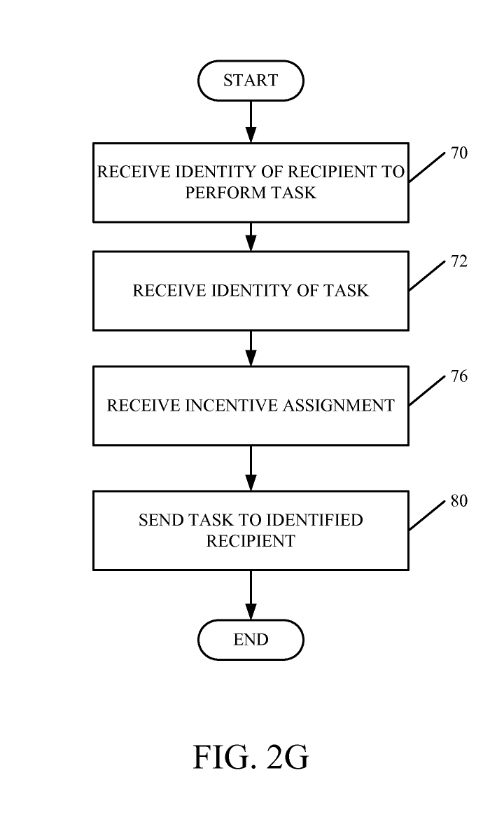

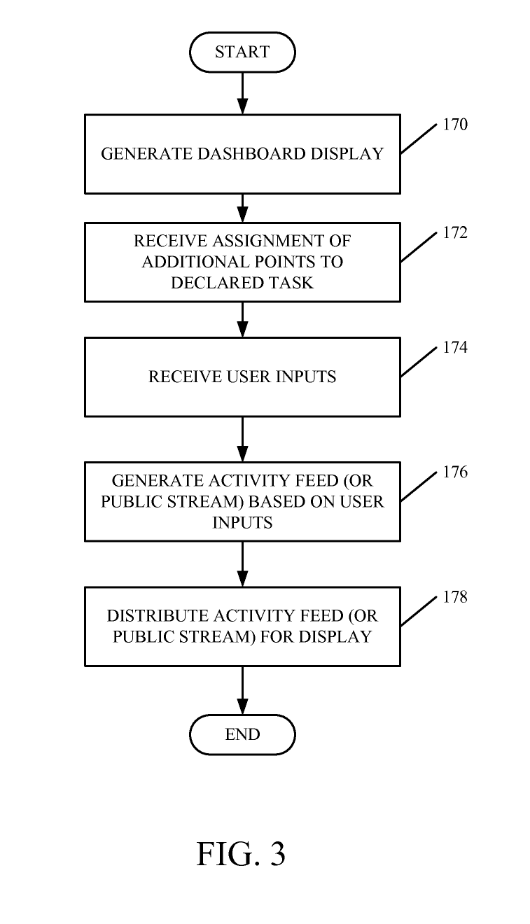

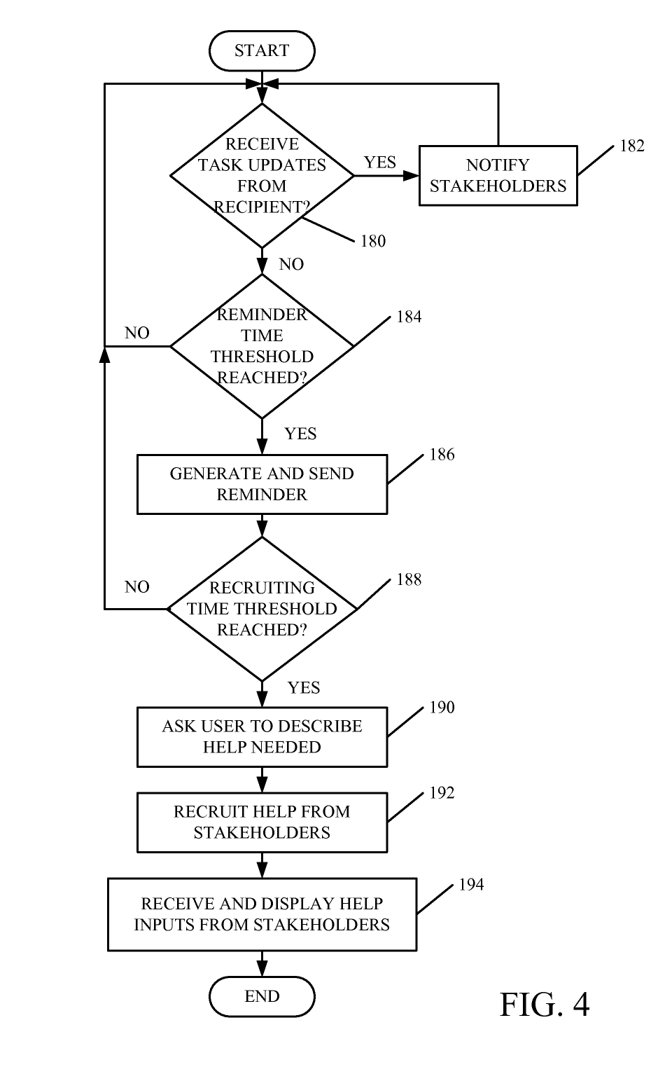

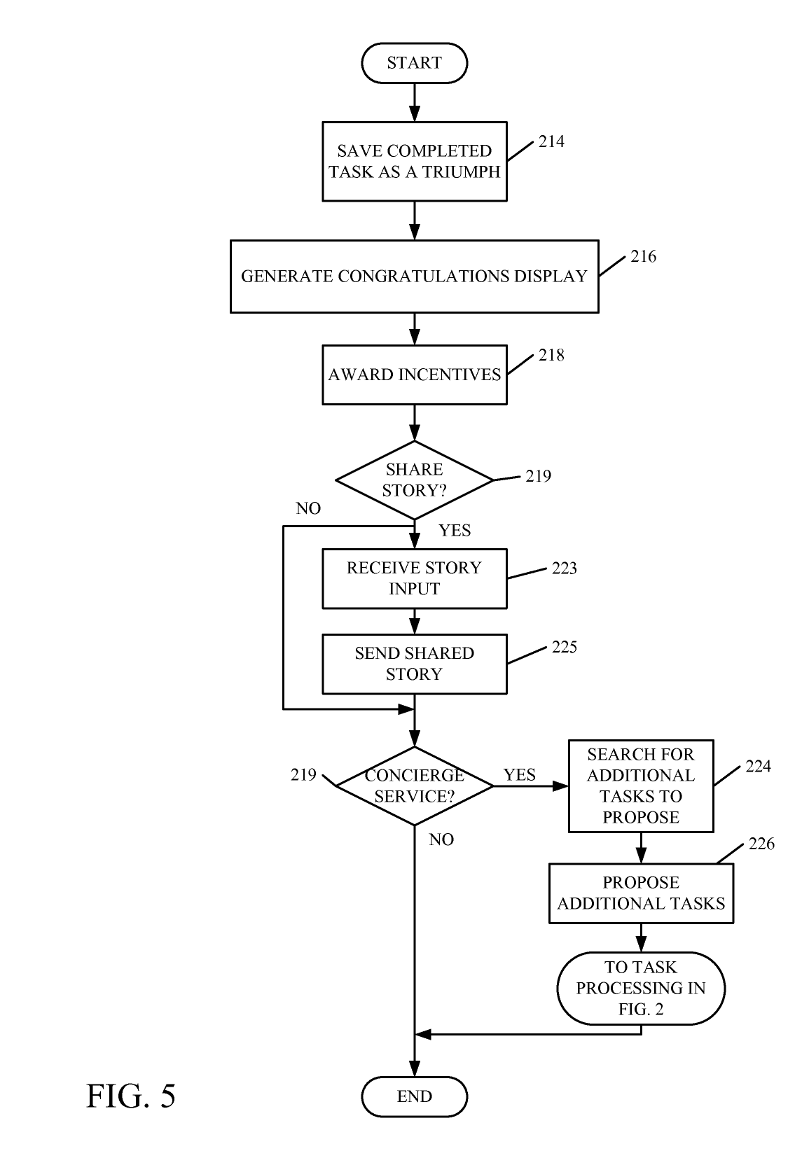

FIG. 2 is a flow diagram illustrating one embodiment of the overall operation of the system shown in FIG. 1. FIG. 2A-2F show embodiments of user interface displays generated for a user of client device 16. FIGS. 2G-5 are more detailed flow diagrams of some of the steps shown in FIG. 2. FIGS. 2-5 will now be described in conjunction with one another.

FIG. 2 shows that, in one embodiment, task generator component 28 of system 10 first receives inputs that generate a task to be completed by a recipient of the task. This is indicated by block 140. FIG. 2G is a flow diagram illustrating one embodiment of the operation of task generator component 28 in generating a task, and FIG. 2G will now be described before returning to FIG. 2.

Generating a task can be done in a variety of ways. For instance, user interface component 12 can generate a user interface display 14 for a user, such as the one shown in FIG. 2A. FIG. 2A shows that, in one embodiment, the display has a tool bar 3 with a plurality of tabs, as well as buttons 5 and 7. This user interface can be generated in response to the user selecting a “Create” tab of the tool bar 3 of the user interface. Of course, other user input mechanisms can be used as well. For instance, the tab can be selected by clicking on it using a point and click device or it can be selected using touch gestures on a touch sensitive display screen or it can be selected using hardware buttons on keypads or in any other desired way. By displaying the user interface shown in FIG. 2A, the user can then select to create a task (or a “Do”) for himself or herself or for someone else.

If the user, for instance, indicates that he or she desires to create a task for someone else (such as by actuating button 5 on the user interface display of FIG. 2A) then task generator 28 and user interface component 12 illustratively generate a user interface display 14 such as that shown in FIG. 2B. The user interface display shown in FIG. 2B allows the user to identify another user, such as by inputting a name in a text box 64, through an appropriate user input mechanism 64. In one embodiment, the user can enter a name by typing text into a text box, or select a user from a scrollable list, or otherwise enter a user who is to receive an invitation to perform a task. Receiving the identity of the recipient who is to perform the task is indicated by block 70 in FIG. 2G.

Next, the user interface display generated by user interface component 12 allows the user to specify the task through another suitable user input mechanism 66. In the embodiment shown in FIG. 2B, task generator component 28 causes user interface component 12 to generate a user interface display with a text box that allows a user to type in the task submitted to the recipient identified through input mechanism 64. Receiving the identity of the task is indicated by block 72 in FIG. 2G.

Task generator component 28 then allows the user who is creating the task to associate an incentive with the task being created. In one embodiment, the user can assign a number of points or another incentive to the task to be performed. This can be done using a variety of different user input mechanisms, such as mechanism 74. In the embodiment shown in FIG. 2B, a plurality of different point levels are selectable by the user. By selecting one of those point levels, the user can indicate how much value is associated with the given task. Of course, points can be assigned in a wide variety of different ways. They can be selected from a list, typed in or otherwise entered or or chosen in another way. In the embodiment shown in FIG. 2B, the user creating the task has assigned the task of “running 10 miles” a value of 20 points. Having system 10 receive the incentive assignment by the user creating the task is indicated by block 76 in FIG. 2G.

The user then illustratively sends the task by providing an appropriate user input, such as by clicking the Send button 78 shown in FIG. 2B. Of course, a variety of other mechanisms can be used to send the task to the recipient as well, and that shown in FIG. 2B is illustrated for example only. Sending the task to the identified recipient is indicated by block 80 in FIG. 2G.

It will be appreciated that, in one embodiment, in order to send the task to the identified recipient, feed generator component 42 identifies the location of the recipient from social graph 60 and provides it to feed distributor component 44, which distributes a public feed to various users connected by social graph 60. The public feed includes the invitation to the recipient identified in the task and will be displayed as a post in the public feed or activity stream generated for the members of the social graph 60.

In addition to appearing in the recipient's public feed, Once the task has been generated and sent to the desired recipient, the desired recipient will illustratively receive a user interface display similar to that shown in FIG. 2B, except that instead of the text “Create a do for?” another text, such as “A Do Has Been Created For You By ______” will be displayed. Also, instead of the Send button 78, an Accept button may be displayed to allow the recipient to accept the task.

In the meantime, (and referring again now to FIG. 2) after the task has been generated and sent to the desired recipient, but before the desired recipient has accepted the task, interaction component 36 (FIG. 1) illustratively allows social interaction to encourage the desired recipient to accept the task. This is indicated by bock 142 in FIG. 2.

FIG. 2C shows one illustrative embodiment of a “dashboard” view generated by feed generator component 42 and user interface component 12. The dashboard view illustratively includes a first column 84 and a second column 86. Column 84 shows the tasks that have been assigned to the user viewing the user interface display of FIG. 2C, and column 86 illustratively displays the tasks assigned to not only the user viewing the display, but other users in social graph 60. It can be seen in column 86 that a display 88 is included as a post in the activity feed or public stream. Post 88 identifies the task created above with respect to FIG. 2B for “Sameer” (the recipient) to “run 10 miles”. Post 88 also shows that the task is pending, in that it has not been accepted yet by the recipient.

When in the dashboard view of FIG. 2C, the person viewing that view can click on any of the posts in columns 84 and 86 to get more details. For instance, assume that a user who is viewing the user interface display of FIG. 2C clicks on post 88, then task generator component 28 illustratively causes user interface component 12 to display a display such as that shown in FIG. 2D. FIG. 2D shows that the task corresponding to post 88 can be displayed in more detail. In one embodiment, the author of the task and the desired recipient are displayed such as in a textual display 90. The task is also illustratively displayed such as in textual display 92, and the status of acceptance of the task is also illustratively displayed such as at textual display 94. Further, textual display 96 illustratively displays the level of incentive (e.g., the number of points) that have been assigned to the task thus far. In addition, display portion 98 illustratively displays various comments that have been made on this task by other members of social graph 60. It will be appreciated that the details of a given task can be shown in a wide variety of different ways and the display shown in FIG. 2D is exemplary only.

If the desired recipient has yet to accept the task, the user viewing the display of FIG. 2D can encourage the recipient to accept by pressing an encourage button 100 (or another similar user input mechanism) which allows the viewer to write an encouraging textual message to the desired recipient of the task. Similarly, the user interface display of

FIG. 2D allows the user to add additional incentive, such as by actuating button 102 (or another suitable input mechanism) to add points to the incentive 96 assigned to the given task.

Interaction component 36 monitors all of the various social inputs from others in the user's social graph 60 that are entered through these types of user input mechanisms and identifies those individuals as stakeholders 62 in the task. In other words, they are individuals who have shown an interest in the desired recipient actually following through and performing the assigned task. In some instances, the stakeholders will be only those individuals who have assigned additional points (or other incentive) to the task, while in other embodiments they may simply be individuals who socially commented on, or liked, the task. In any case, interaction component 36 illustratively identifies stakeholders in the task, based on the social input received, as indicated by block 150 in FIG. 2.

Also, in one embodiment, all the social interaction received for a given task is monitored by interaction component 36 and provided to feed generator component 42. Component 42 illustratively generates a public feed or activity stream with posts representing that social interaction and provides it to feed distributor component 44 which distributes the public feed or activity stream to the various members of social graph 60. In this way, all the members of the social graph can see who has provided social input corresponding to a given task. For instance, feed distributor component 44 illustratively generates the posts shown in column 86 of FIG. 2C. It also illustratively updates those posts with posts showing any additional social interaction that has been received for a given task. Thus, when a user clicks on one of the posts, and the more detailed view of FIG. 2D is shown, all the various components of social interaction that have been received with respect to that task are displayed or are displayable from the view shown in FIG. 2D.

It should also be noted, that, in one embodiment, receiving social input (at 142 in FIG. 2) can also include receiving social input from the recipient who has been assigned the task. In other words, it may be that the recipient does wish to perform the task, but would like more incentive. In that case, task generator component 28 and interaction component 36 cause user interface component 12 to generate a negotiation interface which allows the desired recipient of the task to negotiate for more points (or for other incentive) from the creator of the task, or from other users in the social graph 60. For instance, the recipient of the task may simply be provided with a text box where the recipient can type a textual statement indicating that he or she does wish to perform the task, but would like additional incentive. Similarly, user interface component 12 may illustratively allow system 10 to generate a user interface that lets the desired recipient of the task ask for members of the social graph to vote on whether the desired recipient should in fact perform the task. Of course, there are a wide variety of other ways of negotiating to receive additional social input to determine whether a user should indeed perform a task.

At some point, however, the user will illustratively accept the task to be performed. When the user accepts the task to be performed, this is interpreted as a declaration of the intent of the user to perform the task. This is indicated by block 152 of FIG. 2. This can be done in a number of different ways. One way was just described and it includes the recipient receiving and accepting a task created by another, as indicated by block 151. Of course, the user can create a task for himself or herself, and this is also interpreted as the user declaring an intent to perform the task. This is indicated by block 153 in FIG. 2.

Once the user has declared an intention to perform the task, then task generator 28 stores the task as a task 50 for the recipient, and also stores the stakeholders 62 and any other social interactions 64 which have happened with respect to that task. These are all stored illustratively in data store 18.

Task generator component 28 then prioritizes the tasks for the recipient based on the social input. This is indicated by block 154 in FIG. 2. The priority of a given task for a given recipient is illustratively based on the social interest expressed by those in the social graph 60 for the recipient. This can be done in a variety of different ways. For instance, in one embodiment, the priority of the tasks assigned to a given recipient are based only on the number of points (or other incentive) assigned to that task by the stakeholders. In another embodiment, the priority of a task is assigned not only based on the number of points assigned, but the number of stakeholders corresponding to that task or the volume of social interaction received for that task or a combination of these or other things as well. The level of social interest expressed can correspond to how important others in the social graph think it is for the recipient to perform the task.

After the task is prioritized, but before it is completed, social task monitoring system 10 identifies and employs social mechanics to assist the recipient in completing the task. This is indicated by block 136 in FIG. 2. FIG. 3 shows one embodiment of employing social mechanics to assist the recipient in performing the task. In the embodiment shown in FIG. 3, system 10 first uses user interface component 12 to generate a dashboard user interface display, such as that shown in FIG. 2C. The user can illustratively click on a number of tabs in the toolbar 13.

If the user clicks on the “Me” tab in the toolbar 13, a display such as that shown in FIG. 2E is generated. The display shown in FIG. 2E illustratively has a display portion 160 that displays the current user viewing the display as well as a leader board portion 162 that shows other users in the social graph 60 of the present viewer and the number of points that they have earned thus far. In one embodiment, the user viewing the display is highlighted, such as by displaying the user's name in a different color text or in a different font than the other users on the leader board. The display also includes administrative items such as a settings display 164, and account display 166 and an “about” display 168, all of these, when actuated, provide additional administrative settings or account information or general information about the system, respectively. In any case, generating the dashboard is indicated by block 170 in FIG. 3.

The leader board 162 shown in FIG. 2E is but one social mechanism for encouraging the recipient to perform the task. By illustrating where the recipient stands relative to other users in the social graph 60, this can provide incentive for the recipient to complete the task and move up in the standings.

In another embodiment, the recipient can receive the assignment of additional points for the task. This is indicated by block 172 in FIG. 3. For instance, if other users are viewing the task assigned to the recipient, and they wish to encourage the recipient to perform the task, they can assign additional points to the task to motivate the recipient to complete the task. Similarly, users in the social graph can provide additional user inputs which will be reflected on the user interface display corresponding to the given task (such as the displays in FIG. 2C or 2D), as indicated by block 174 in FIG. 3. There are a variety of different types of social user inputs that can be received in order to encourage the user to complete the task. For instance, the user can “like” or “unlike” a given task. The user can also “comment” on a task by typing encouraging messages or other messages which may assist the user in completing the task. Similarly, of course, a wide variety of other inputs could be used as well.

Whenever there is any social input into system 10, interaction component 36 tracks those interactions, and saves them in the appropriate location in data store 18. Interaction component 36 also illustratively provides this information to feed generator component 42 which generates the public stream or activity feed and provides that to feed distributor component 44 which distributes it to other members of social graph 60. Generating the activity feed (or public stream) based on the user inputs and distributing it for display is indicated by blocks 176 and 178 in FIG. 3.

FIG. 4 is a flow diagram illustrating another embodiment of identifying and employing social mechanics to assist the recipient in completing the task (as referenced at block 156 in FIG. 2). It will be noted that system 10 can employ user interface 12 to allow the recipient to input task updates. For instance, where the task is to run 10 miles, the recipient of the task may provide an input (such as by providing a comment) that states that the user has run 5 miles on a given day. The task updates may indicate that the recipient is moving along mile posts in the direction of performing the task. Alternatively, of course, the task updates can be a certain obstacle faced by the recipient (e.g., a running injury) or a request for help by the recipient, or any other task update input by the recipient as well. Receiving task updates is indicated by block 180 in FIG. 4.

When any of the task updates are received, notification system 34 identifies the various stakeholders 62 for the given task and provides that information to feed generator component 42 which generates a public stream (or activity feed) 71. Feed distributor component 44 then distributes the public stream to the various stakeholders corresponding to this task, notifying them of the task update. This is indicated by block 182 in FIG. 4.

If, after a certain amount of time, no task updates have been received from the recipient at block 180, then reminder generator component 30 determines whether a sufficient amount of time has passed that the recipient might need a reminder. This is indicated by block 184 in FIG. 4. This can be done in a variety of different ways. For instance, the creator of the task may indicate how often the recipient needs to be reminded. Similarly, the reminder time threshold can start at a first given time period, and decrease over time so that the recipient is getting reminded more often, the more time goes by before task completion or between task updates. A variety of other reminder systems can be used as well.

In any case, if the reminder time threshold has been reached, then reminder generator component 30 generates a user interface display, using user interface component 12, reminding the user that the task has yet to be completed. A wide variety of reminder displays (including audio/visual reminder displays) can be used. This is indicated by block 186 in FIG. 4.

Help generator component 32 also determines whether enough time has passed that the stakeholders 62 in the task need to be recruited to help or assist the recipient in performing the task. For instance, it may be that a relatively long amount of time has passed or a predetermined number of reminders have been sent, without the recipient having updated any information relative to the task. At that point, help generator component 32 illustratively can perform in a number of different ways. If a recruiting time threshold has been reached, as indicated by block 188 in FIG. 4, then help generator component 32 can simply generate a user interface display (using user interface component 12) to the recipient asking the recipient to describe what help is needed in order to perform the task. This may be as simple as providing a predefined message such as “What help do you need in order to perform this task?” along with a text box to receive the recipient's response, describing what type of help is needed. Other user input mechanisms can be used as well. For instance, the recipient can be allowed to select from a list of possible help items to describe the help needed. Giving the recipient the opportunity to describe the help needed to perform a task is indicated by block 190 in FIG. 4.

Generator component 32 can (either in response to the user requesting help at block 190, or automatically) recruit help from the various stakeholders 62 for the given task. In that embodiment, help generator component 32 illustratively generates messages to the stakeholders. The messages can be provided by feed distributor component 44 as posts in the public stream 71 of those stakeholders 62, indicating that the recipient has yet to perform the task, and further indicating that the recipient may need help or further encouragement to perform the task. The post can include the recipient's request for help, where desired. Recruiting help from the stakeholders is indicated by block 192 in FIG. 4.

The stakeholders 62 can provide help in a number of different ways. They can simply send a message to the recipient using feed distributor component 44 which shows up as a post in the public stream of the recipient. Alternatively, the stakeholders can go to the screen such as that shown in FIG. 2D and increase the point level corresponding to the task, or provide an encouraging message or comment to the recipient. Receiving and displaying (for the recipient) help inputs from the stakeholders 62 is indicated by block 194 in FIG. 4.

It should be noted, while a variety of types of identifying and employing social mechanics to assist the recipient in completing the task (shown at block 156 in FIG. 2) have been described, others can be used as well. For instance, the system 10 can employ other mechanisms such as electronic mail, or messages on third party social networks or text messages or other messaging inputs to provide encouragement or help to the recipient in performing the tasks. Different types of reminders can be used, and a wide variety of different types of social input and incentive can be solicited for the recipient or used in other ways.

In any case, it is assumed that the recipient eventually completes the task. When the task is completed as indicated by block 200 in FIG. 2, system 10 illustratively performs post-completion processing as indicated by block 202.

FIG. 5 shows a flow diagram illustrating one embodiment of the operation of system 10 shown in FIG. 1 in performing post-completion processing. In the embodiment shown in FIG. 5, the recipient illustratively provides a user input through a user interface display that the recipient has completed a given task. This can be done in a variety of different ways. For instance, when viewing the dashboard display shown in FIG. 2C, the recipient may select one of the received tasks from column 84. In that case, user interface component 12 illustratively displays more information corresponding to the task and provides a user interface component that allows the user to indicate that the user has completed the task. When this happens, interaction component 36 illustratively saves the completed task as a triumph 56 in data store 18. Incentive system 38 then illustratively generates a congratulations display such as that shown in FIG. 2F.

In the embodiment shown in FIG. 2F, the task is identified in an upper portion 210 of FIG. 2F, and the point standings after completion of the task are indicated in a lower portion 212. Saving the completed task as a triumph is indicated by block 214 in FIG. 5 and generating the congratulations display is indicated by block 216. Incentive system 38 also awards the incentive points corresponding to the task to the recipient and stores them as points 58 in data store 18 corresponding to the recipient. Awarding the incentives is indicated by block 218 in FIG. 5.

After the incentives have been awarded at block 218, the user can choose whether to share his or her story of the triumph. This is indicated by block 219. For instance, when the user is shown the user interface display of FIG. 2F, the display may provide a user input mechanism such as a Share button 221. When the user actuates this button, a triumph message can be generated to all the stakeholders 62 for the respective task. In addition, the system may allow the user to input additional information describing the story.

By way of example, if the task is to run 10 miles, the user may be provided a text box where the user can textually describe what took place during the 10 mile run, how difficult it was, express thanks to all the stakeholders, etc. Receiving the story to be shared is indicated by block 223 and sending the shared story to the stakeholders 62 (such as by posting it to their public stream or activity feed, or by sending them a private message) is indicated by block 225 in FIG. 5.

It should be noted, in one embodiment, system 10 can act as a concierge service as well. That is, system 10 can automatically suggest additional tasks to be performed by the given recipient upon the completion of a given task, or at any time during processing. This can be done in a variety of different ways.

For instance, interest tracking component 26 illustratively tacks the explicit and implicit interests of the given users of the system. Explicit interests are those interests which a given user specifically identifies as being “of interest”. For instance, interest tracking component 26 can generate user interfaces for the given users and allow them to specifically mark subject matter areas or people as being of interest. These are explicit interests of the user.

In addition, however, interest tracking component 26 illustratively analyzes the various interactions of the given users to implicitly identify their interests. For instance, the subject matter of tasks generated by the user for himself or herself or tasks accepted by the user will be deemed of interest. Also, if a given user provides a social interaction with respect to a given task of another indicating that the user “likes” the task or “comments on” the task, then interest tracking component 26 illustratively identifies the subject matter of that task as being of interest to the user. Similarly, the recipient of any tasks (and its subject matter) where the user is a stakeholder may be implicitly determined as being of interest to that user. Of course, other mechanisms for implicitly determining the interests of a given user can be used as well.

In any case, once the interests of a given user are determined, task generator component 28 can automatically generate tasks in those subject matter areas for the user. If so, system 10 is acting as a concierge service. This can be set up in the preferences of a user when a user establishes an account with system 10, or it can be set up in other ways as well. Determining whether system 10 is to act as a concierge service for a given user is indicated by block 220 in FIG. 5.

If so, then once a task is completed (or at any other time during processing) task generator component 28 can automatically search for additional tasks to propose to the given user. This is indicated by block 224 in FIG. 5. Task generator component 28 can then automatically propose the additional tasks to the user as indicated by block 226. Processing then proceeds as indicated in FIG. 2. When that processing is completed, or if, at block 222, it is indicated that system 10 is not to act as a concierge service at this time, processing is completed.

Referring again to FIG. 1, it can be seen that system 10 can interface with vendors 24 as well. For instance, a plurality of different vendors may provide products or services related to the tasks that are to be completed by the users of system 10. In that case, vendor interface component 20 can provide a vendor interface display 22 to the vendors 24 that allow the vendors to specifically advertise their products or services to individual recipients of tasks that are related to that vendor. Similarly, the interface can allow the vendors 24 to proactively generate offers (such as discounts) to those recipients.

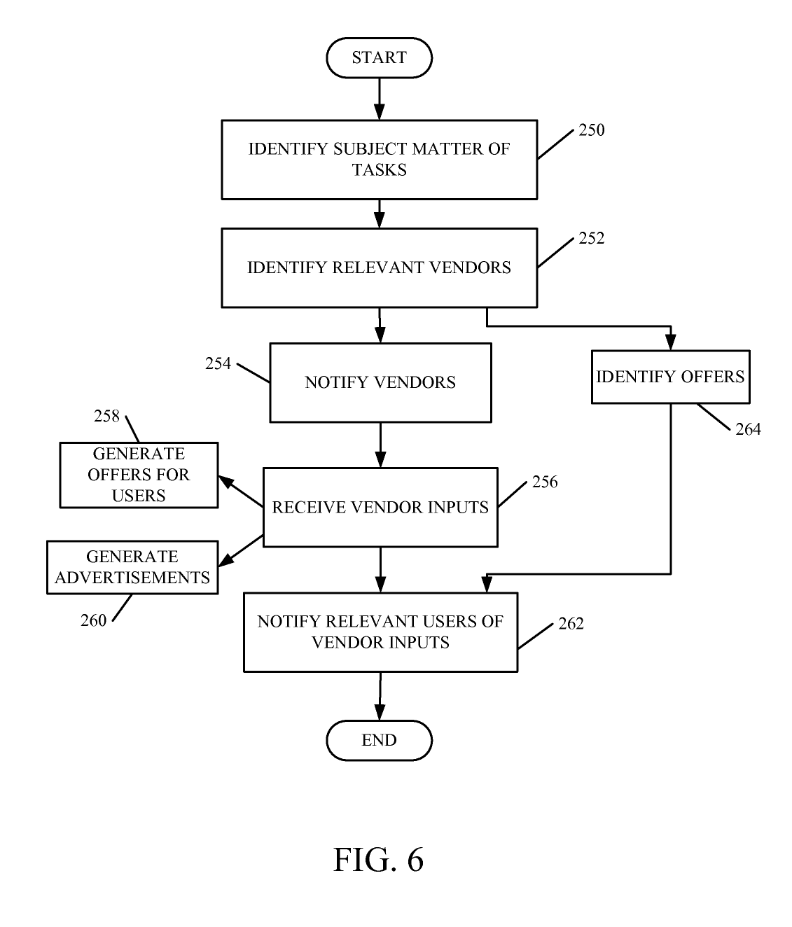

FIG. 6 is a flow diagram illustrating one embodiment of the operation of system 10 in interacting with vendors 24. Vendor component 46 first identifies the subject matter of the various tasks that are to be completed, or have been completed, in system 10. This is indicated by block 250 in FIG. 6. This can be done using natural language processing, key word matching against stored subject matter key words, or in any other desired way.

Vendor component 46 then illustratively identifies relevant vendors 24 corresponding to the subject matter. This is indicated by block 252 and can be done in a wide variety of different ways. For instance, the vendors may register with system 10 by providing keywords related to their products or services. Vendor component 46 can thus compare keywords corresponding to the subject matter of the tasks in system 10 with the keywords corresponding to the vendors to identify a match. When that occurs, notification system 34 can be used to notify vendors 24 that there are relevant tasks in system 10. This is indicated by block 254. Vendor interface component 20 can then provide a vendor interface display 22 that allows the vendors to provide inputs, such as advertising or offers corresponding to the recipients or stakeholders or both associated with the relevant tasks. This is indicated by block 256. Generating offers for the users of system 10 is indicated by block 258 and generating advertising is indicated by block 260. Then, notification system 34 notifies the relevant users of the vendor input. This is indicated by block 262.

In a different embodiment, vendor component 46 stores (in data store 18 or elsewhere) a set of preexisting offers that are provided by vendors 24. Then, vendor component 46 searches the data store of outstanding offers to see whether any are relevant to the tasks in system 10. Identifying such offers is indicated by block 264 in FIG. 6. The relevant users of system 10 are then notified of those preexisting offers.

In yet another embodiment, interface component 20 can provide vendors 24 with an interface that allows the vendors to proactively search the various tasks 50 in system 10. When the vendors 24 find relevant tasks that are relevant to their products or services, they can then provide specific advertisements or offers to the recipients of, or stakeholders in, those tasks as well. Of course, other vendor interactions can be performed as well.

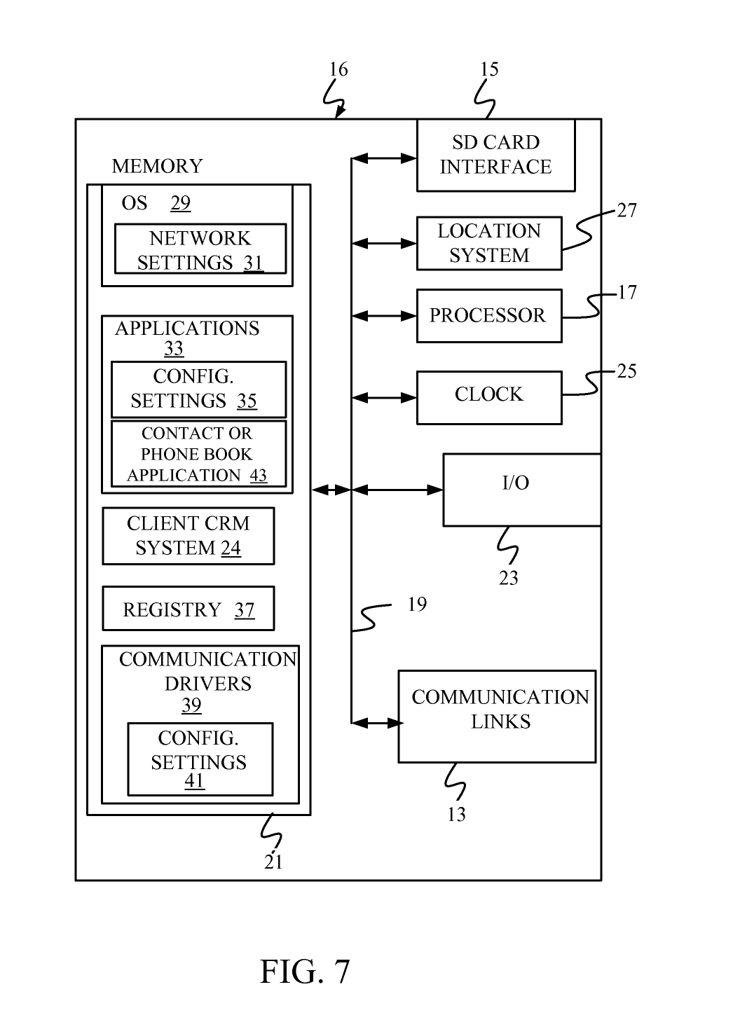

FIGS. 7-9 show a number of different embodiments for client device 16. While these embodiments will be described in FIGS. 7-9, it should be noted that these are not exclusive, but are provided as illustrative and exemplary descriptions of embodiments of client device 16.

It will also be noted that as shown in FIG. 1, system 10, or various components of system 10, can reside elsewhere, other than on client device 16. For instance, it could be embodied in a cloud computing environment. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 10 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client device 16 directly, or in other ways.

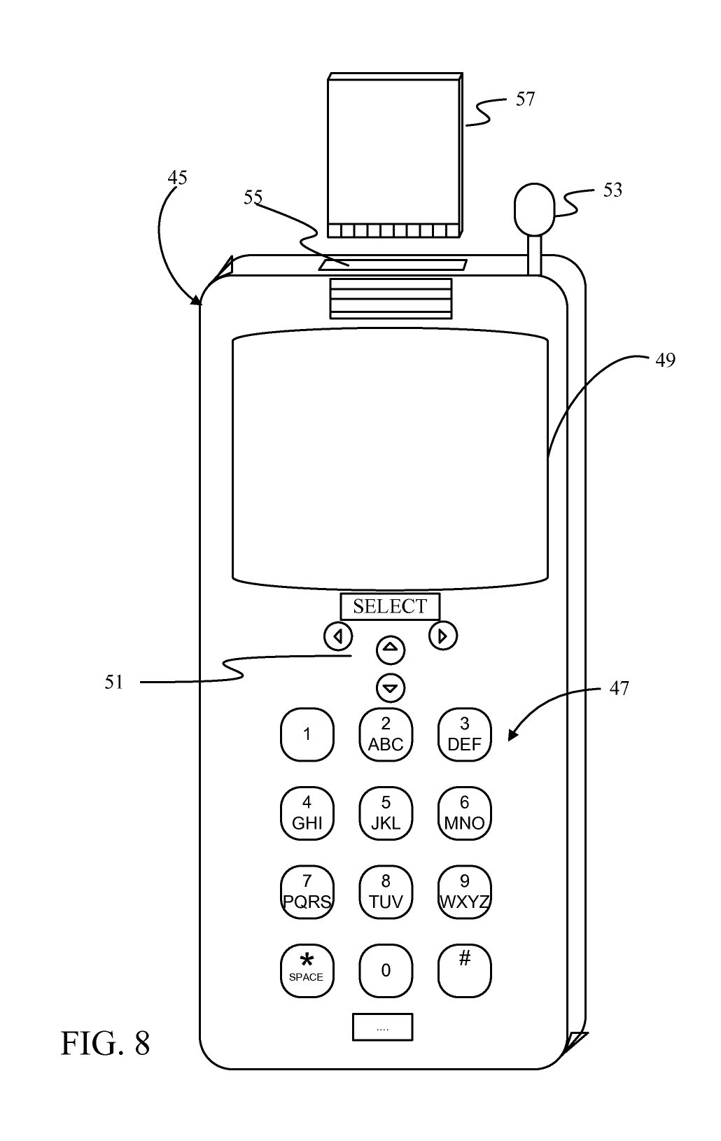

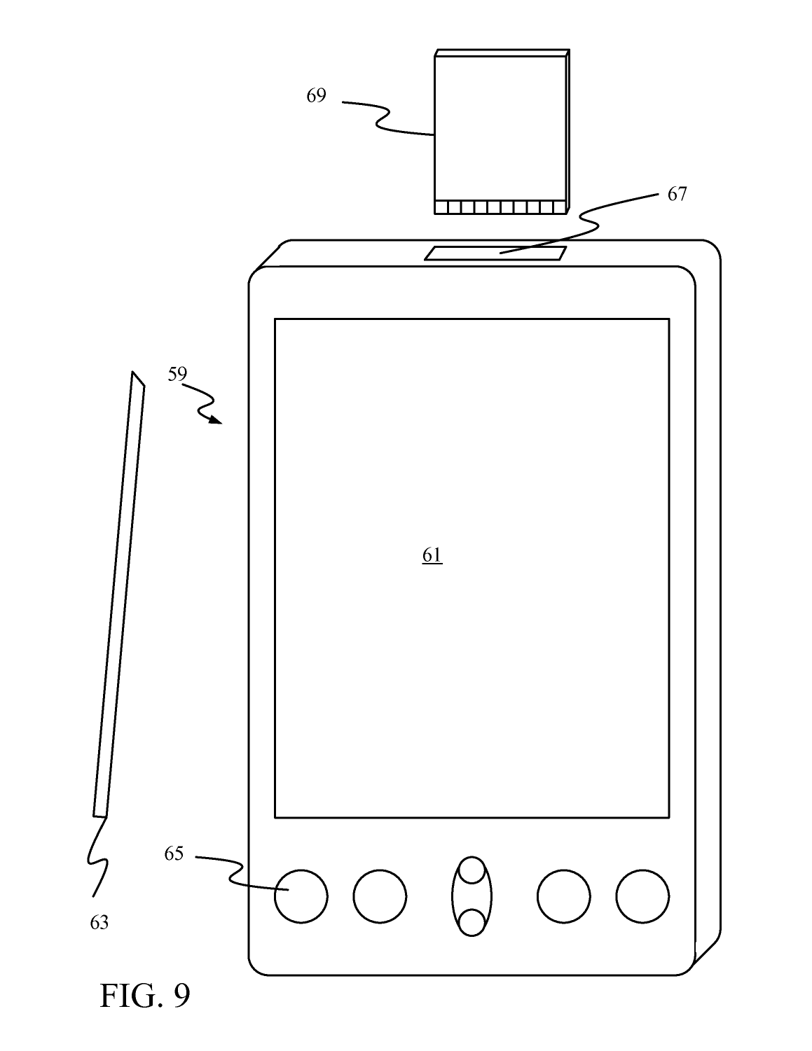

In any case, FIG. 7 is a simplified block diagram of one illustrative embodiment of a handheld or mobile computing device that can be used as client device 16, in which the present system can be deployed. FIGS. 8 and 9 are examples of handheld or mobile devices.

FIG. 7 provides a general block diagram of the components of a client device 16 that can run components of system 10 or that interacts with system 10, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 10) are received on a removable Secure Digital (SD) card that is connected to a SD card interface 15. SD card interface 15 and communication links 13 communicate with a processor 17 (which can also embody processor 48 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, touch screens, proximity sensors, microphones, tilt sensors, and gravity switches and output components such as a display device, a speaker, and or a printer port. Other I/0 components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, registry 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 10 or the items in data store 18, for example, can reside in memory 21. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIGS. 8 and 9 provide examples of devices 16 that can be used, although others can be used as well. In FIG. 8, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 9 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible. Examples include tablet computing devices, music or video players, and other handheld computing devices.

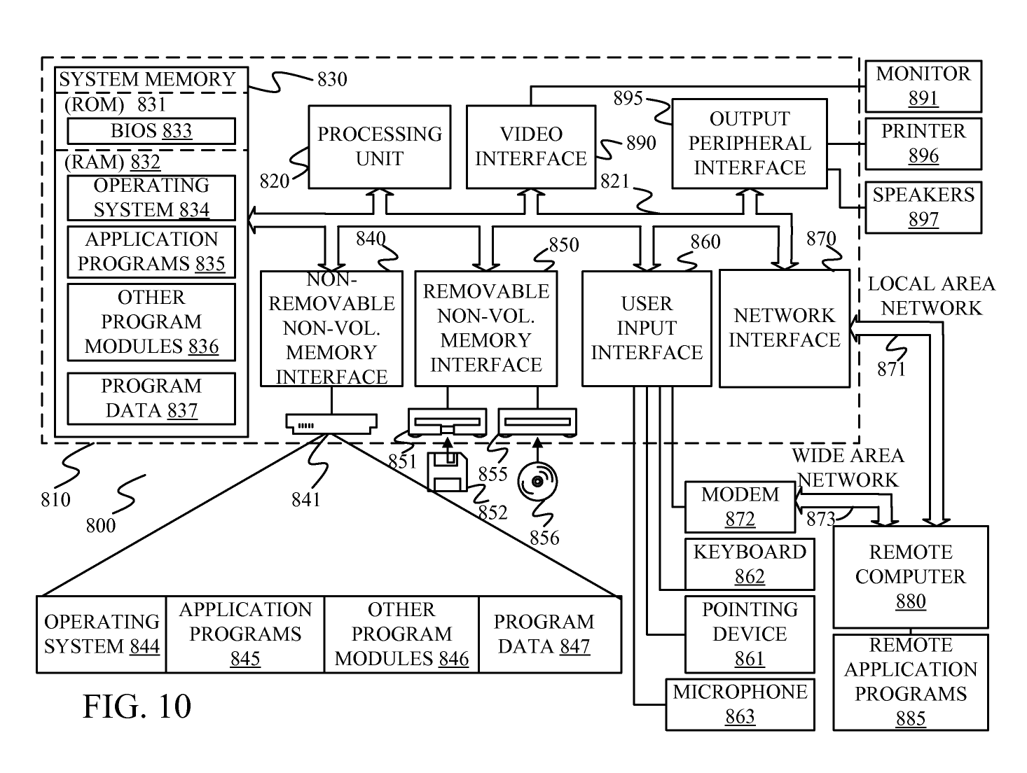

FIG. 10 is one embodiment of a computing environment in which system 10 (for example) can be deployed. With reference to FIG. 10, an exemplary system for implementing some embodiments includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. They can also include search components 802 and 804.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of monitoring task completion, using a computer with a processor, comprising:
receiving, at the processor, and displaying as a post in a public stream distributed to the user and members of a social graph corresponding to the user, an intent input indicative of a user intent to complete a task;
receiving, at the processor, and displaying as a post in the public stream, inputs related to the task from members of the social graph corresponding to the user;
identifying stakeholders in the task, with the processor, based on the inputs received from the members of the social graph;
receiving, at the processor, a completion input indicative of user completion of the task; and
publishing a post in the public stream, indicative of the user completion of the task, to the user and the stakeholders.

2. The computer-implemented method of claim 1 wherein receiving inputs related to the task from members of the social graph comprises:
receiving an offer of an incentive, for completion of the task, from at least one member of the social graph; and
displaying, as a post in the public stream, an incentive display indicative of the offer of the incentive.

3. The computer-implemented method of claim 2 and further comprising:
in response to receiving the completion input, awarding an aggregated incentive to the user indicative of an aggregate of all incentive offered by the at least one member of the social graph; and
displaying, as a post in the public stream, an award display indicative of the award of the aggregated incentive.

4. The computer-implemented method of claim 3 wherein receiving inputs related to the task from the members of the social graph comprise:
prior to receiving the completion input, receiving social inputs from the members of the social graph encouraging the user to complete the task; and
displaying, as a post in the public stream, the social inputs encouraging the user to complete the task.

5. The computer-implemented method of claim 4 wherein receiving social inputs encouraging the user to complete the task, comprises:
receiving an award of additional incentive; and
displaying, as a post in the public stream, a display indicative of the award of the additional incentive.

6. The computer-implemented method of claim 4 wherein receiving social inputs encouraging the user to complete the task, comprises:
receiving a comment; and
displaying, as a post in the public stream, a display indicative of the comment.

7. The computer-implemented method of claim 4 wherein receiving social inputs encouraging the user to complete the task, comprises:
receiving an input indicative of a member of the social graph liking the task; and
displaying, as a post in the public stream, a display indicative of the member of the social graph liking the task.

8. The computer-implemented method of claim 3 and further comprising:
prior to receiving the completion input, receiving status inputs indicative a status of task completion; and
displaying, as a post in the public stream, a display indicative of the status inputs.

9. The computer-implemented method of claim 3 and further comprising:
prior to receiving the completion input, determining whether a reminder should be generated; and
if so, generating a reminder display indicative of a reminder of the task to be completed.

10. The computer-implemented method of claim 3 and further comprising:
prior to receiving the completion input, determining whether to recruit help; and
if so, displaying, as a post in the public stream, a display indicative of a request for help in the user completing the task.

11. The computer-implemented method of claim 3 and further comprising:
prior to receiving the completion input, generating a leader board display displaying, in rank order, the user and other members of the social graph, ranked based on incentives received for completing tasks.

12. The computer-implemented method of claim 1 wherein publishing the post indicative of user completion of the task comprises:
receiving a story input indicative of a user description of completing the task; and
displaying, as a post in the public stream, a display indicative of the story input.

13. The computer-implemented method of claim 1 and further comprising:
prioritizing the task for the user, relative to other tasks to be completed by the user, based on the inputs from the members of the social graph.

14. The computer-implemented method of claim 1 wherein identifying stakeholders comprises:
identifying the members of the social graph that offered incentive for performing the task.

15. The computer-implemented method of claim 1 wherein identifying stakeholders, comprises:
identifying the members of the social graph that provided a social input related to the task.

16. The computer-implemented method of claim 1 and further comprising:
identifying a subject matter of tasks assigned to users;
identifying relevant vendors based on the subject matter identified; and
notifying the relevant vendors that they have been identified.

17. The computer-implemented method of claim 16 and further comprising:
receiving from a relevant vendor an advertising input relevant to the subject matter of one or more of the tasks assigned to the users; and
displaying the advertising input to the users.

18. A task monitoring system, comprising:
a task generator component generating a task to be completed by a user;
a feed generator component generating posts in a public feed;
a feed distributor component distributing the public feed to members of a social graph associated with the user;
an interaction component receiving social inputs from members of the social graph related to the task and identifying stakeholders in the task based on offers of incentive to complete the task in the social inputs;
a help generator component recruiting help, from the stakeholders, for the user in completing the task;
an incentive system aggregating the incentive offered from the stakeholders and awarding the aggregated incentive upon the user indicating that the task is complete, the incentive system ranking, and displaying in rank order, the user and other members of the social graph based on total incentives awarded for performing tasks; and
a computer processor, being a functional component of the system and activated by the task generator component, the feed generator component, the feed distributor component, the interaction component, the help generator component, and the incentive system to facilitate generating a task, generating a post, distributing the public feed, identifying stakeholders, recruiting help, aggregating and awarding incentive, and ranking.

19. The task monitoring system of claim 18 and further comprising:
a vendor component identifying vendors relevant to the task, notifying the relevant vendors, receiving promotional messages from the relevant vendors and displaying the promotional messages to the user.

20. A computer readable storage medium having computer readable instructions stored thereon which, when executed by a computer, cause the computer to perform steps, comprising:
receiving, at the processor, and displaying as a post in a public stream distributed to the user and members of a social graph corresponding to the user, an intent input indicative of a user intent to complete a task;
receiving, at the processor, and displaying as a post in the public stream, inputs related to the task from members of the social graph corresponding to the user, comprising an offer of an incentive, for completion of the task;
prioritizing the task for the user, relative to other tasks to be completed by the user, based on the inputs from the members of the social graph;
identifying stakeholders in the task, with the processor, based on the inputs received from the members of the social graph;
determining whether to recruit help;
if help is to be recruited, displaying, as a post in the public stream to the stakeholders, a display indicative of a request for help for the user in completing the task;
receiving, at the processor, a completion input indicative of user completion of the task;
publishing a post in the public stream, indicative of the user completion of the task, to the user and the stakeholders;
in response to receiving the completion input, awarding an aggregated incentive to the user indicative of an aggregate of all incentive offered by the at least one member of the social graph; and
displaying, as a post in the public stream, an award display indicative of the award of the aggregated incentive.
